(19) United States
(12) Patent Application Publication
(10) Pub. No.: US 2007/0274687 A1
(43) Pub. Date: Nov. 29, 2007

(54) Video Signal Encoder, A Video Signal Processor, A Video Signal Distribution System And Methods Of Operation Therefor

(75) Inventors: Christiaan Varekamp, Eindhoven (NL); Piotr Wilinski, Eindhoven (NL); Mark Fransiscus Agnes Schroders, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/598,271

(22) PCT Filed: Feb. 22, 2005
(86) PCT No.: PCT/IB05/50637

§ 371 Date: Jun. 19, 2007

(30) Foreign Application Priority Data
Mar. 1, 2004 (EP) 04100806.1

(51) Int. Cl. H04N 7/26

(52) U.S. Cl. 386/109

(57) ABSTRACT

A video encoder (100) comprises a receiver (101) which receives an uncompressed video signal. An encoding element (103) generates a compressed video signal in accordance with a compression algorithm, such as an MPEG-2 encoding algorithm. In addition, a feature point processor (105) generates feature point data (105) in response to the uncompressed signal, and an output processor (107) generates an output video signal which comprises the compressed video signal and the feature point data. The output signal is received by a receiver (201) of a video signal processor (200). An extraction processor (203) extracts the feature point data and feeds it to a video processor unit (207) which processes the compressed video signal in response to the feature point data. The separate and independent generation of feature point data, such as feature point movement data or tracks using the uncompressed (original) video signal, eliminates or reduces the impact of compression artifacts, inaccuracies and errors on feature point locations and trajectories when these are detected using the compressed signal.

A video signal encoder, a video signal processor, a video signal distribution system and methods of operation therefor

The invention relates to a video signal encoder, a video signal processor, a video signal distribution system and methods of operation therefor and in particular but not exclusively to feature point tracking in video signals.

In recent years, the use of digital storage and distribution of content signals such as video signals have become increasingly prevalent. Accordingly, a large number of different encoding techniques for different content signals have been developed. For example, a number of video encoding standards have been designed to facilitate the adoption of digital video in many professional- and consumer applications and to ensure compatibility of equipment from different manufacturers.

Most influential standards are traditionally developed by either the International Telecommunications Union (ITU-T) or the MPEG (Motion Pictures Experts Group) committee of the ISO/IEC (the International Organization for Standardization/the International Electrotechnical Committee). The ITU-T standards, known as recommendations, are typically aimed at real-time communications (e.g. videoconferencing), while most MPEG standards are optimized for storage (e.g. for Digital Versatile Disc (DVD)) and broadcast (e.g. for Digital Video Broadcast (DVB)).

Currently, one of the most widely used video encoding and compression techniques is known as the MPEG-2 (Motion Picture Expert Group) standard. MPEG-2 is a block based compression scheme wherein a frame is divided into a plurality of blocks each comprising eight vertical and eight horizontal pixels. For compression of luminance data, each block is individually compressed using a Discrete Cosine Transform (DCT) followed by quantization which reduces a significant number of the transformed data values to zero thereby providing for efficient coding. For compression of chrominance data, the amount of chrominance data is usually first reduced by down-sampling followed by compression using the DCT and quantization. Frames based only on intra-frame compression are known as Intra Frames (I-Frames). Furthermore, motion estimation is used to exploit temporal redundancy. The differential motion vectors for image segments are transmitted and used by the decoder to reconstruct the image.

It is expected that future video applications will comprise complex signal processing functionality and will provide advanced features and functions. For example, image object detection and tracking is currently being investigated. An example of a video application using object tracking is an application where a football object and player objects are detected in a video signal and used for example to generate different virtual camera angles or game statistics.

Another example of an application currently receiving significant attention is three-dimensional (3D) processing based on two-dimensional (2D) video. For example, conventional video and TV systems distribute video signals which inherently are 2D in nature. However, it would in many applications be desirable to further provide 3D information.

In particular three dimensional video or television (3DTV) is promising as a means for enhancing the user experience of the presentation of visual content and 3DTV could potentially be as significant as the introduction of color TV. The 2D-to-3D conversion process adds (depth) structure to 2D video and may also be used for video compression. However, the conversion of 2D video into video comprising 3D information is a major image processing challenge. Consequently, significant research has been undertaken in this area and a number of algorithms and approaches have been suggested for extracting 3D information from 2D images.

Algorithms have been proposed for object tracking and 3D processing which are based on parameters of encoded video signals. However, these parameters are not optimized for the accuracy of the described object trajectory but for visual quality. For example, the current implementations of video compression algorithms typically use motion vectors associated with fixed square shaped image regions (blocks) for estimation and storage of image motion vectors. However, block-based motion vectors are not very well suited for accurate tracking because the motion per block is not accurate enough to form long tracks of over typically 50 frames.

Furthermore, object tracking and 3D processing based on frames regenerated from an encoded video signal tend to have reduced accuracy due to artifacts, errors and inaccuracies introduced by the encoding/compression.

Also, known algorithms for processing encoded video signals tend to be complex and require high computational resource.

Hence, an improved video encoder, video decoder and video distribution system would be advantageous and in particular a system facilitating and/or improving processing of video signals for applications such as object detection, tracking and/or 3D processing.

Accordingly, the Invention preferably seeks to mitigate, alleviate or eliminate one or more of the above mentioned disadvantages singly or in any combination.

According to a first aspect of the invention, there is provided a video signal encoder comprising: means for receiving an uncompressed video signal; means for generating feature point data in response to the uncompressed signal; means for compressing the uncompressed video signal in accordance with a compression algorithm to generate a compressed video signal; and means for generating an output video signal comprising the compressed video signal and the feature point data.

The invention provides for a video signal encoder that provides an output video signal suitable for facilitated and/or improved processing. The output video signal comprises feature point data relating to the uncompressed video signal. This feature point data may be of increased accuracy as the effect of encoding or compression artifacts, inaccuracies and errors can be reduced or eliminated. The invention may further allow an output signal which may be processed with lower complexity as processing to generate feature point information may be reduced or obviated.

Hence, additional feature point data, which has been generated from an uncompressed video signal, may be provided in addition to a compressed video signal thereby allowing additional and/or improved information suitable for subsequent processing. Specifically, accurate feature point information may be included which allows for improved and/or facilitated 3D processing (including construction of 3D information from 2D images) and/or object detection and/or tracking.

A separate or independent generation of the feature point data allows the generation and resulting data to be independent of any restrictions, requirements or deficiencies associated with the compression algorithm. The compression algorithm may be part of or may include an encoding algorithm. The uncompressed signal may be in any suitable form and may already be encoded in accordance with a given encoding standard allowing for further compression or re-encoding and compression. Thus, the video signal encoder may for example be part of a video transcoder.

The additional information may result in an increased data rate of an output video signal. However, this increased data rate may be insignificant and/or acceptable in most applications. Furthermore, as the feature point data may specifically comprise information related only to simple feature points rather than image segments or objects, the feature point data may be efficiently communicated with a data rate typically much lower than the data rate of the compressed video signal.

According to a feature of the invention, the feature point data comprises feature point movement data.

The feature point movement data may for example be feature point trajectory data and/or relative movement data associated with one or more identified feature points. This may provide information particularly suitable for object tracking and 3D reconstruction processing.

According to another feature of the invention, the feature point data comprises parametric data relating to a motion model for one or more feature points.

This may provide low data rate feature point movement information which is suitable e.g. for object tracking of objects performing complex motions.

According to another feature of the invention, the feature point data comprises group information related to a grouping of feature points associated with at least one frame of the uncompressed signal.

This may provide for a reduced data rate associated with the feature point data and may facilitate processing of the output video signal and in particular of the feature point data. For example, if groups correspond to image objects, object tracking processing may be significantly facilitated.

According to another feature of the invention, the feature point data comprises common (or shared) movement data for a group of feature points associated with at least one frame of the uncompressed signal. This information is particularly useful for many applications and processes including object tracking and 3D reconstruction.

According to another feature of the invention, the feature point data does not comprise feature point absolute position data. This may reduce the data rate required to communicate the feature point data. As an example, rather than providing absolute position values for each data point in each frame, relative position values indicating the movement of the feature point from one frame to the next may be provided. As the relative movement values typically are relatively small, a more efficient encoding/compression of the data values can be achieved.

According to another feature of the invention, the means for generating feature point data is operable to detect at least one feature point in a first frame of the uncompressed video signal and to track the at least one feature point in at least a second frame of the uncompressed video signal. This provides a low complexity way of generating feature point data suitable for e.g. object tracking and 3D reconstruction applications.

According to another feature of the invention, the means for generating feature point data is operable to group feature points and to generate shared feature point data for each group of feature points. This provides a practical and efficient way of generating feature point data which may be efficiently communicated and/or which may facilitate processing of the output video signal.

According to another feature of the invention, the video signal encoder further comprises decoding means for decompressing the compressed video signal in accordance with a decompressing algorithm to generate a decompressed signal and wherein the means for generating feature point data is further operable to generate the feature point data in response to the decompressed signal.

The decompressing algorithm may be substantially identical to a decompressing algorithm to be used for decompressing the compressed video signal in a decoder. For example, if the compressed video signal is encoded in accordance with the MPEG-2 encoding standard, the decompressing algorithm may be the appropriate MPEG-2 algorithm. The video encoder may for example generate a decompressed signal and detect feature points in this signal in accordance with a specific algorithm, which is further known to be used in a given decoder. The information of which feature points will be identified in the decoder may then be used to select the same feature points at the encoder and to include these feature points in the feature point data. This may reduce the data rate of the feature point data and thus the data rate of the output video signal as a whole.

According to another feature of the invention, the means for generating feature point data is operable to generate feature point data relating to only a subset of frames of the uncompressed video signal. This may substantially reduce the data rate required to communicate the feature point data. The subset of frames may be selected in accordance with a suitable selection criterion. For example, every N'th frame may be used. A video signal processor receiving the signal from the video encoder may generate suitable feature point data related to other frames by interpolation between the feature point data of the output video signal.

According to a second aspect of the invention, there is provided a video signal processor comprising: means for receiving a video signal comprising a compressed video signal and feature point data associated with an uncompressed version of the compressed video signal; means for extracting the feature point data; means for processing the compressed video signal in response to the feature point data.

The means for processing the compressed video signal may be operable to directly process the compressed video signal or may comprise a conversion into a second signal to which an algorithm may be applied. For example, the compressed video signal may be decoded prior to a given algorithm or process being applied to the signal. Hence, the processing of the compressed video signal may be a multiple step processing including generating a derived signal followed by a processing of the derived signal in response to the feature point data.

The invention provides for a video signal processor that may exploit the feature point data associated with an uncompressed signal to provide facilitated and/or improved processing of the corresponding compressed signal. This feature point data may be of increased accuracy as the effect of encoding or compression artifacts, inaccuracies and errors can be reduced or eliminated. The compressed video signal may be processed with lower complexity as processing to generate feature point information may be reduced or obviated.

It will be appreciated that advantages and/or features of the video encoder may readily be translated to, correspond to and may be applied to the video signal processor as appropriate.

According to a feature of the invention, the means for processing is operable to perform image object tracking in frames of the compressed video signal in response to the feature point data. Hence, the invention may provide for facilitated and/or improved image object tracking.

According to a feature of the invention, the means for processing is operable to perform three-dimensional (3D) information processing of the compressed video signal in response to the feature point data. The 3D information processing may specifically be a 3D reconstruction process which derives 3D information from 2D images. Hence, the invention may provide for facilitated and/or improved 3D information processing.

According to a third aspect of the invention, there is provided a video signal distribution system comprising: a video encoder comprising: means for receiving an uncompressed video signal, means for generating feature point data in response to the uncompressed signal, means for compressing the uncompressed video signal in accordance with a compression algorithm to generate a compressed video signal, and means for generating an output video signal comprising the compressed video signal and the feature point data; and a video signal processor comprising: means for receiving the output video signal, means for extracting the feature point data, and means for processing the compressed video signal in response to the feature point data.

According to a fourth aspect of the invention, there is provided a method of encoding a video signal, the method comprising the steps of: receiving an uncompressed video signal; generating feature point data in response to the uncompressed signal; compressing the uncompressed video signal in accordance with a compression algorithm to generate a compressed video signal; and generating an output video signal comprising the compressed video signal and the feature point data.

According to a fifth aspect of the invention, there is provided a method of decoding a video signal, the method comprising the steps of: receiving a video signal comprising a compressed video signal and feature point data associated with an uncompressed version of the compressed video signal; extracting the feature point data; and processing the compressed video signal in response to the feature point data.

According to a sixth aspect of the invention, there is provided a method of distributing a video signal, the method comprising the steps of: at a video encoder performing the steps of: receiving an uncompressed video signal, generating feature point data in response to the uncompressed signal, compressing the uncompressed video signal in accordance with a compression algorithm to generate a compressed video signal, and generating an output video signal comprising the compressed video signal and the feature point data; and at a video signal processor (200) performing the steps of: receiving the output video signal, extracting the feature point data, and processing the compressed video signal in response to the feature point data.

These and other aspects, features and advantages of the invention will be apparent from and elucidated with reference to the embodiment(s) described hereinafter.

An embodiment of the invention will be described, by way of example only, with reference to the drawings, in which

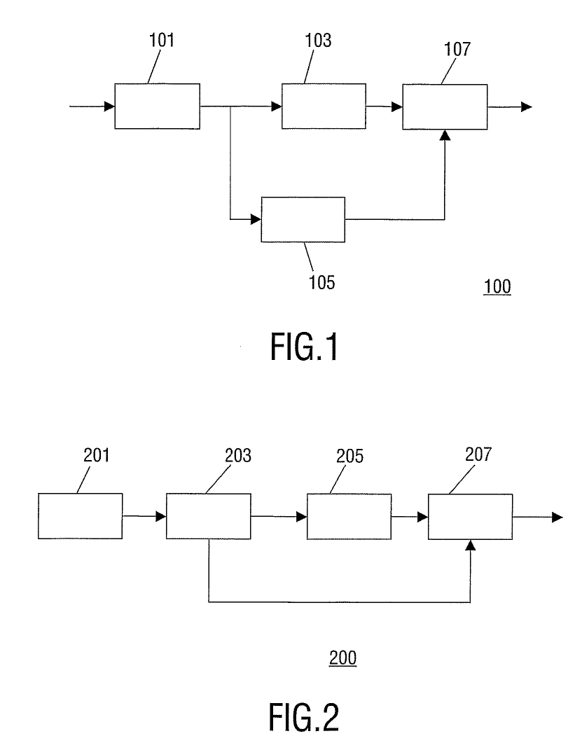

FIG. 1 is an illustration of a block diagram of video signal encoder in accordance with an embodiment of the invention; and

FIG. 2 is an illustration of a block diagram of a video signal processor in accordance with an embodiment of the invention.

The following description focuses on an embodiment of the invention applicable to a video signal encoder and video signal processor and in particular to encoding and processing of MPEG-2 video signals. However, it will be appreciated that the invention is not limited to this application.

FIG. 1 illustrates a block diagram of a video signal encoder 100 in accordance with an embodiment of the invention. The video signal encoder 100 comprises a receiver 101 which receives an uncompressed video signal from an internal or external source (not shown).

The receiver 101 is coupled to an encoding element 103 which is fed the uncompressed signal from the receiver 101. The encoding element 103 encodes the uncompressed signal to generate an encoded and compressed signal. Thus, the encoding of the uncompressed video signal is in accordance with a given encoding protocol which comprises compression of the video signal data.

In the specific embodiment, the encoding element 103 encodes the uncompressed signal in accordance with the MPEG-2 standard.

The video signal encoder 100 further comprises a feature point processor 105 coupled to the receiver 101 and operable to process the uncompressed signal to generate feature point data. Specifically, the feature point processor 105 may detect a number of feature points in frames of the compressed signal and determine the location of these feature points. The feature point processor 105 may subsequently perform a feature correspondence estimation process in order to associate corresponding feature points in different frames thereby generating trajectory or track information for the feature points.

The encoding element 103 and the feature point processor 105 are further coupled to an output processor 107 which generates an output signal by generating an output data stream which comprises both the compressed video signal data and the feature point data. Specifically, the output processor 107 may insert the feature point processor 105 into ancillary (or auxiliary or user) data sections of the compressed MPEG-2 data from the encoding element 103.

Thus, the video signal encoder 100 generates an output signal comprising the compressed encoded video signal as well as separately and independently generated feature point data. The feature point data is generated on the basis of the uncompressed signal and is therefore not affected by coding artifacts, inaccuracies and errors introduced by the encoding element 103. This provides feature point data which is of higher accuracy than feature point information that may be generated by a video signal processor or encoder based on the compressed video signal. The data rate increase associated with the inclusion of the feature point data in the output video signal is typically insignificant or at least acceptable. Hence, an output video signal that may improve and/or facilitate processing in a video signal processor is generated. Specifically, the feature point data may provide improved accuracy of the algorithms or applications which use feature points.

FIG. 2 illustrates a block diagram of a video signal processor 200 in accordance with an embodiment of the invention. In the example, the video signal processor 200 specifically comprises a video decoder which generates a decompressed signal which is then processed. However, it will be appreciated that the invention is not limited to this application and that the video signal processor 200 may for example process the compressed video signal without first decoding this.

The video signal processor 200 comprises a receiving element 201 which receives the output video signal from the video signal encoder 100 of FIG. 1. The video signal processor 200 further comprises an extraction processor 203 coupled to the receiving element 201. The extraction processor 203 separates the feature point data and the compressed video signal data. In particular, the extraction processor 203 may demultiplex the incoming data by extracting the feature point data from the auxiliary data sections of the MPEG-2 data stream.

In the illustrated embodiment, the video signal processor 200 further comprises a video decoding element 205 which is coupled to the extraction processor 203 and which receives the compressed video signal data after the feature point data has been extracted. The video signal processor 200 decodes the compressed video signal and generates a decoded video signal.

The video signal processor 200 further comprises a video processor unit 207 which is coupled to the extraction processor 203 and the video decoding element 205. The video processor unit 207 receives the feature point data from the extraction processor 203 and the decoded video signal from the video decoding element 205. The video processor unit 207 may then process the decoded video signal in response to the feature point data. This processing may for example comprise modifying characteristics or data of the decoded video signal dependent on the feature point data or may comprise determining parameters or statistics associated with the decoded video signal in response to the feature point data. Specifically, the processing of the video processor unit 207 may comprise object tracking of image objects of the decoded video signal or may comprise deriving 3D information for the decoded video signal in response to both the decoded video signal and the feature point data.

In the following, more details of an embodiment suitable for a distribution system comprising object tracking functionality at one or more video processors will be described. The embodiment will be described with reference to the video signal encoder 100 and video signal processor 200 of FIGS. 1 and 2 respectively.

In the specific embodiment, the feature point processor 105 initially detects a number of feature points in the frames of the uncompressed video signals. The feature points correspond to points in the image which have been detected in accordance with a suitable feature point detection algorithm. Typically, the feature points will be points that have a given characteristic which indicates that they may potentially correspond to for example a corner of an image object or an intersection or junction between image objects.

It will be appreciated that any suitable algorithm for detection of feature points may be used without detracting from the invention.

In the specific embodiment, the feature point processor 105 first performs a feature response calculation, and in particular the feature point processor 105 determines the Harris response. Further details of the Harris corner detection algorithm may be found in “A combined corner and edge detector” by C. Harris and M. Stephens, Proceedings of the fourth Alvey Vision Conference, Aug. 31-Sep. 2, 1988. It will be appreciated that any suitable feature detector may be used without detracting from the invention.

Once the Harris response has been determined, the result is used to determine feature points in accordance with any suitable algorithm. For example feature points may be determined by selecting only those points that achieve a maximum of the Harris response in a circular window of fixed radius (e.g. 20 pixels). This provides the benefit that points are uniformly distributed over the image plane. Furthermore only points with a Harris response larger than a given minimum are preferably selected.

After the feature points have been detected in a plurality of frames, the feature point processor 105 performs a feature correspondence estimation. This algorithm seeks to determine the correspondence between the detected feature points in different frames and for example seeks to determine which object corner feature points in different frames correspond to the same object corner. Thus, for each feature point in a first frame, the algorithm searches for a best corresponding feature point in a second image based on a suitable match criterion. This search is done in a circular window of fixed radius (e.g. 20 pixels) to avoid false matches. An example of a match criterion is to use the sum of absolute differences between the image pixel values of both images. The summation is for instance over a local square region centered on the feature point. Temporal filtering or prediction may be used to improve the position of the search window that is used to identify the corresponding feature point.

In the specific embodiment the feature point processor 105 then proceeds to generate feature point movement data for corresponding feature points in different frames. Specifically, feature points track data is generated by indicating the initial spatial location of each feature point track followed be the relative spatial locations for the corresponding feature points in other frames.

In the specific embodiment, the feature point data is generated to comprise the spatial location (x and y), an identifier (ID) and a start-of-track indicator variable (SOT) for each feature point. The SOT variable is used to indicate whether or not data for a given feature point is the first in a new track (or trajectory) or is a continuation of the previous track having that specific ID. This allows the same ID to be re-used unambiguously to identify a new track.

Instead of coding the spatial location (x,y) of a feature point, the displacement vector (Δx, Δy) from the corresponding feature point of the previous frame is preferably coded. This can be done for all feature points in a track except for the initial feature point for which the absolute spatial location is given. By coding the relative location coordinates (Δx, Δy) rather than the absolute location coordinates (x,y) increased compression may be achieved as the relative location coordinates are generally of lower magnitude and therefore can be represented by fewer bits. The start-of-track indicator provides information to the video signal processor 200 indicating whether given data is relative or absolute location coordinates.

Thus, in this embodiment the video signal encoder 100 generates feature point data which comprises feature point movement data and specifically feature point track data. The video signal processor 200 is thus provided with accurate information of the movement of different feature points over multiple frames. By clustering the feature points into clusters of similar motion, an analysis of the video in terms of moving objects may be enabled or facilitated.

In some embodiments, the feature points may thus be grouped by the feature point processor 105. Specifically, the feature points may be grouped together in groups of feature points having corresponding movement parameters and common or shared movement data may be provided for the group of feature points rather than for each individual feature point. This may provide for a significantly reduced data rate required for communicating the feature point data.

The feature point data may thus preferably comprise group information which indicates which feature points correspond to which feature point group as well as one set of common movement data for each feature point group. For example, rather than including absolute or relative spatial location data for each individual feature point a single coordinate set is provided for all feature points in a given feature point group.

It will be appreciated that any suitable criterion or algorithm for grouping feature points may be applied. For example, a plurality of feature points may correspond to the same rigidly moving object e.g. feature points may be detected on the image object of a car in motion. These feature points will tend to have similar motion characteristics. Such feature points may for example be detected by a graph based clustering algorithm. As an example, a neighbor graph, where each feature point is connected to its nearest k neighbors, may be generated using all feature points in an image. Thus, for each point the graph has a connection with its k spatially nearest points. Edges in the graph are then cut if the motion difference between the points is greater than a given threshold. The result is a set of sub-graphs with each sub-graph corresponding to a feature point group.

In some embodiments, the feature point data may comprise parametric data which relates to a motion model for a feature point or preferably a feature point group.

Typically, a group of feature point tracks can be accurately described by a single model with a small number of parameters. Accordingly, a model may be fitted to the motion of the features in a group.

The parameters determined by this fitting may then be included in the feature point data. Thus, for each feature point group, the model parameters may be encoded and transmitted to the video signal processor 200. Preferably, the video signal processor 200 has knowledge of the model used (alternatively this information may be included in the feature point data) and simply applies the received parameters to generate movement data of the features in the group. The data rate for the resulting feature point data will depend on the number of feature point groups and the number of bits that are used to represent the model parameters. The coding can be lossy or lossless. Typically, a relatively low data rate in comparison to the data rate of the compressed video signal may be achieved. In addition, the complexity and computational resource of the object tracking processing in the video signal processor 200 may be reduced significantly as only simple model evaluation is required.

In some embodiments, feature points are detected and movement data is generated for all frames of the video signal. However, in other embodiments only a subset of frames are processed and the feature point data is only generated for this subset. Thus, the feature point data may only comprise information for a subset of frames for each feature point. In a simple such embodiment, feature point data is generated only for every other frame (or every N'th frame). This may significantly reduce the data rate associated with the feature point data and may also significantly reduce the complexity and computational resource consumption of the video signal encoder.

In this embodiment, the video signal processor only receives feature point data related to the subset of frames. However, feature point information related to other frames may be derived in response to the received feature point data. For example, feature point locations for a given frame may be derived by interpolating between the corresponding location in past and future frames.

In some embodiments, the subset of frames for which feature point data is derived may be in response to characteristics of the uncompressed video signal and/or the compressed video signal. For example, feature point data may be generated only for I-frames of an MPEG-2 encoded compressed signal.

The video signal processor 200 may in some embodiments comprise functionality for performing 3D information processing of the compressed video signal in response to the feature point data. For example, 3D information may be extracted for static scenes using structure from motion algorithm and knowledge of the camera parameters as is known in the art.

In some embodiments, the video signal encoder may also comprise a decoding element which can decompress the compressed video signal in accordance with a decompressing algorithm. Specifically, the decoding element may emulate the decoding to be performed in a video signal processor and may thus use the same or similar decompression (or decoding) algorithm as used in the video signal processor. Thus, the decoding element may generate a video signal which is identical or very similar to that which is to be generated by the video signal processor.

In such embodiments, the feature point processor preferably generates the feature point data in response to the video signal generated by the decoding element. For example, the video signal encoder may detect feature points in the decoded signal which correspond directly to feature points that may be independently detected by the video signal processor. The corresponding feature points detected in the uncompressed signal may be determined and the movement data for these feature points may be associated with the feature points of the decoded signal. The feature point data may consequently comprise only the movement data without a specific indication of the feature points.

Thus, in some embodiments, some decoder functionality of the video signal processor may be repeated in the video signal encoder thereby allowing for information independently generated at both ends to be used to reduce a data rate of the output video signal. Thus, a flexible trade of between complexity and computational resource and data rate of the output video signal is achieved.

The invention can be implemented in any suitable form including hardware, software, firmware or any combination of these. However, preferably, the invention is implemented as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units and processors.

Although the present invention has been described in connection with the preferred embodiment, it is not intended to be limited to the specific form set forth herein. Rather, the scope of the present invention is limited only by the accompanying claims. In the claims, the term comprising does not exclude the presence of other elements or steps. Furthermore, although individually listed, a plurality of means, elements or method steps may be implemented by e.g. a single unit or processor. Additionally, although individual features may be included in different claims, these may possibly be advantageously combined, and the inclusion in different claims does not imply that a combination of features is no feasible and/or advantageous. In addition, singular references do not exclude a plurality. Thus references to “a”, “an”, “first”, “second” etc do not preclude a plurality.

1. A video signal encoder comprising:
means for receiving (101) an uncompressed video signal;
means for generating feature point data (105) in response to the uncompressed signal;
means for compressing (103) the uncompressed video signal in accordance with a compression algorithm to generate a compressed video signal; and
means for generating an output video signal (107) comprising the compressed video signal and the feature point data.

2. A video signal encoder as claimed in claim 1 wherein the feature point data comprises feature point movement data.

3. A video signal encoder as claimed in claim 1 wherein the feature point data comprises parametric data relating to a motion model for one or more feature points.

4. A video signal encoder as claimed in claim 1 wherein the feature point data comprises group information related to a grouping of feature points associated with at least one frame of the uncompressed signal.

5. A video signal encoder as claimed in claim 1 wherein the feature point data comprises common movement data for a group of feature points associated with at least one frame of the uncompressed signal.

6. A video signal encoder as claimed in claim 1 wherein the feature point data does not comprise feature point absolute position data.

7. A video signal encoder as claimed in claim 1 wherein the means for generating feature point data (105) is operable to detect at least one feature point in a first frame of the uncompressed video signal and to track the at least one feature point in at least a second frame of the uncompressed video signal.

8. A video signal encoder as claimed in claim 1 wherein the means for generating feature point data (105) is operable to group feature points and to generate common feature point data for each group of feature points.

9. A video signal encoder as claimed in claim 1 further comprising decoding means for decompressing the compressed video signal in accordance with a decompressing algorithm to generate a decompressed signal and wherein the means for generating feature point data is further operable to generate the feature points data in response to the decompressed signal.

10. A video signal encoder as claimed in claim 1 wherein the means for generating feature point data (105) is operable to generate feature point data relating to only a subset of frames of the uncompressed video signal.

11. A video signal processor comprising:
means for receiving a video signal (201) comprising a compressed video signal and feature point data associated with an uncompressed version of the compressed video signal;
means for extracting (203) the feature point data; and
means for processing (207) the compressed video signal in response to the feature point data.

12. A video signal processor as claimed in claim 11 wherein the means for processing (207) is operable to perform image object tracking in frames of the compressed video signal in response to the feature point data.

13. A video signal processor as claimed in claim 11 wherein the means for processing (207) is operable to perform three-dimensional information processing of the compressed video signal in response to the feature point data.

14. A video signal distribution system comprising:
a video encoder (100) comprising:
means for receiving (101) an uncompressed video signal,
means for generating feature point data (105) in response to the uncompressed signal,
means for compressing (103) the uncompressed video signal in accordance with a compression algorithm to generate a compressed video signal, and
means for generating an output video signal (107) comprising the compressed video signal and the feature point data; and
a video signal processor (200) comprising:
means for receiving (201) the output video signal,
means for extracting (203) the feature point data, and
means for processing (207) the compressed video signal in response to the feature point data.

15. A method of encoding a video signal, the method comprising the steps of:
receiving an uncompressed video signal;
generating feature point data in response to the uncompressed signal;
compressing the uncompressed video signal in accordance with a compression algorithm to generate a compressed video signal; and
generating an output video signal comprising the compressed video signal and the feature point data.

16. A method of decoding a video signal, the method comprising the steps of:
receiving a video signal comprising a compressed video signal and feature point data associated with an uncompressed version of the compressed video signal;
extracting the feature point data; and
processing the compressed video signal in response to the feature point data.

17. A method of distributing a video signal, the method comprising the steps of:
at a video encoder (100) performing the steps of:
receiving an uncompressed video signal,
generating feature point data in response to the uncompressed signal,
compressing the uncompressed video signal in accordance with a compression algorithm to generate a compressed video signal, and
generating an output video signal comprising the compressed video signal and the feature point data; and
at a video signal processor (200) performing the steps of:
receiving the output video signal,
extracting the feature point data, and
processing the compressed video signal in response to the feature point data.

18. A computer program enabling the carrying out of a method according to claim 15.

19. A record carrier comprising a computer program as claimed in claim 18.
